(19) United States
(12) Patent Application Publication
(10) Pub. No.: US 2026/0296100 A1
(43) Pub. Date: Oct. 1, 2026

(54) WHEEL HUB UNIT WITH NOISE REDUCING FEATURES

(71) Applicant: AKTIEBOLAGET SKF, GOTEBORG (SE)

(72) Inventors: Riccardo NARDICCHIA, Torino (IT); Ivan MAURO, Bricherasio (IT)

(21) Appl. No.: 19/573,485

(22) Filed: Mar. 20, 2026

(30) Foreign Application Priority Data
Mar. 27, 2025 (IT) 102025000006477

(51) Int. Cl. B60B 27/00; F16C 33/58; F16C 33/62

(52) U.S. Cl. CPC B60B 27/0005; B60B 27/0094; F16C 33/581; F16C 33/62; B60B 2310/54; B60B 2310/642; B60B 2360/102; B60B 2380/12; B60B 2380/73; B60B 2900/133; F16C 2202/04; F16C 2223/10; F16C 2326/02

(57) ABSTRACT

A wheel hub unit for vehicles includes a radially outer ring, a radially inner ring and a plurality of rolling elements interposed between the inner ring and outer ring so as to make them relatively rotatable. The inner ring has an annular surface which is axially inner and axially abutting, the annular surface being superficially hardened and textured by means of a laser device so as to have an arithmetic mean roughness (Ra) ranging between 10 µm and 25 µm and a profile with an average depth ranging between 85 µm and 150 µm.

### CROSS-REFERENCE

This application claims priority to Italian patent application no. 102025000006477 filed on Mar. 27, 2025, the contents of which are fully incorporated herein by reference.

### BACKGROUND OF THE INVENTION

The present invention relates to a wheel hub units, and more particularly to a wheel hub unit attaining a high silence level for vehicles and forming part of a wheel hub assembly. In addition to the wheel hub unit, a constant velocity joint and/or a vehicle suspension upright may also form part of the wheel hub assembly.

It is known that in vehicle wheel hub assemblies “micro-slipping” may occur, which are localized between surfaces of parts of the wheel hub assembly and which are otherwise stably coupled together, for example between an attachment flange of a radially outer ring of a wheel hub unit, integrally coupled, by means of screws or bolts, to a vehicle suspension upright; or also between an inner ring of a vehicle wheel hub unit intended to receive a driving wheel and the portion of a constant velocity joint which is angularly coupled integrally together with the inner ring (or part thereof) by means of a grooved coupling.

Although the wheel hub unit and the other component (constant velocity joint or suspension upright) are angularly coupled together, torque reversals of the vehicle (for example during parking maneuvers), as well as accelerations thereof or also regenerative braking in electric vehicles, may result in a spontaneous relative movement of the surfaces arranged in sliding contact with each other, causing the conversion of static friction, which prevents a relative rotational movement of the two surfaces, into dynamic friction, albeit along very small gradient sections due to the assembly play between the wheel hub unit and the other component (constant velocity joint or suspension upright).

This localized micro-slipping, even though so minimal as to be imperceptible, nevertheless causes noise during use, in particular when intense localized stresses are applied to the wheel hub assembly, as during a steering movement or a reversing movement. This noise is caused by stick-slip effects between the contact surfaces of the wheel hub unit and the surface contacting the constant velocity joint.

Such noise was barely perceptible in traditional vehicles equipped with internal-combustion engines, due to the background noise produced by the engine. However, in modern electric vehicles, which are generally very quiet, it may be annoying for the users or drivers and in particular lead a person to suspect malfunctions of the wheel hub assembly and/or its components, which are in fact non-existent.

In order to reduce or eliminate such noise, various solutions are known, each of which is based on inserting additional elements, such as shims or washers, between the mating surfaces which may be subject to localized micro-slipping during use. Such as shims or washers with a low coefficient of friction are disclosed in Japanese Patent No. 2020051444A and with a high coefficient of friction are disclosed in US Patent No. 8,038,353 B2.

These solutions, however, are relatively costly, since they require the use of an additional element between the interfaces and, in particular, result in an additional volume or space requirements which are not always acceptable, may be difficult to assemble and are subject to wear which may affect both the additional element itself and the necessary anti-corrosion linings or coatings applied by way of protection onto the metal surfaces which are coupled together.

### SUMMARY OF THE INVENTION

An object of the present invention is to provide a wheel hub unit for vehicles which overcomes the drawbacks of the prior art and which is simple and low-cost to produce. The wheel hub unit forms part of a wheel hub assembly further comprising at least one bell member of a constant velocity joint.

In particular, it is an object of the invention to provide a wheel hub unit which during use is not subject to micro-slipping and which is therefore substantially silent when acted on by external stresses, such as steering or torque reversals, when used in vehicles, while remaining substantially simple in terms of construction and assembly and having small dimensions and relatively low assembly costs.

According to the present invention a wheel hub unit for vehicles having the characteristic features set forth in the attached claims is therefore provided.

### BRIEF DESCRIPTION OF THE SEVERAL VIEWS OF THE DRAWINGS

The invention will now be described with reference to the attached drawings which illustrate a non-limiting example of embodiment thereof, in which:

FIG. 1 shows, in schematic form and radially cross-sectioned, a first embodiment of a wheel hub unit according to the present invention;

FIG. 2 shows, in schematic form and radially cross-sectioned, a second preferred embodiment of a wheel hub unit according to FIG. 1;

FIG. 3 shows, in schematic form and radially cross-sectioned, the wheel hub unit according to FIG. 1 and a device for implementing the invention; and

FIG. 4 shows in schematic form, on a significantly larger scale, a preferred embodiment of the present invention as regards the micro-structure.

### DETAILED DESCRIPTION OF THE INVENTION

With reference to FIG. 1, a wheel hub assembly 1 for a vehicle is shown. The wheel hub assembly 1 comprises a wheel hub unit 2 including a rolling bearing 3, in the example shown of the mixed type with two rows of rolling elements (balls) and a bell member 50 of a constant velocity joint 60 (both schematically shown in FIG. 1 and of the known type).

The wheel hub unit 2 is designed to support, in a rotatable manner about an axis A of rotation, a wheel (not shown) of a vehicle and is able to be assembled, axially end-to-end, with the bell member 50 of the constant velocity joint 60 for the transmission of a driving torque to the wheel.

In the entire present description and claims, the terms and the expressions indicating positions and orientations such as "radial" and "axial" are understood as being in relation to the central axis of rotation A of the wheel hub unit 2. Terms such as "axially outer" and "axially inner", refer instead to the assembled condition of the wheel hub unit and, in the case in question, preferably relate to a wheel side and a side opposite to the wheel side, respectively.

The wheel hub unit 2 comprises a radially outer ring 6, a radially inner ring 7 and a plurality of rolling elements 8. In the example shown, the plurality of rolling elements 8 consist of two rows of balls arranged alongside each other and interposed between the inner ring 7 and outer ring 6 so that they can be rotated relative to each other.

The rings 6 and 7 and the rolling elements 8 form part of the rolling bearing 3. In the non-limiting example shown, the rolling bearing 3 is of the so-called “third generation” type and therefore forms directly and in its entirety the wheel hub unit 2, since the outer ring 6 comprises a known flange 9 for attachment to the suspension upright (not shown for simpler illustration), formed integrally as one piece with the outer ring 6, and since the inner ring 7 comprises a (known) attachment flange 10 for the vehicle wheel (not shown for simplified illustration) formed integrally as one piece with the inner ring 7, in particular with an axial end 11 thereof opposite to the flange 9 and to a second end 12 of the inner ring 7.

In a more conventional solution, instead, the flanges 9 and/or 10 would be formed on a wheel hub or spindle provided with the rolling bearing 3 without one or both the flanges 9 and 10, but with its rings 6 and 7 angularly connected to the flange 9 and 10, respectively.

In the non-limiting, but preferred example shown, the inner ring 7 is also divided up, in a known configuration, into two separate elements which are angularly coupled integrally together, in particular one consisting of an annular element formed by the ends 11, 12 and by the flange 10, which are formed as one piece, and the other one consisting of a (known) insert ring 13 mounted embedded on the end 12 in axial abutment against an axial shoulder 14 of the inner ring 7 facing the end 12.

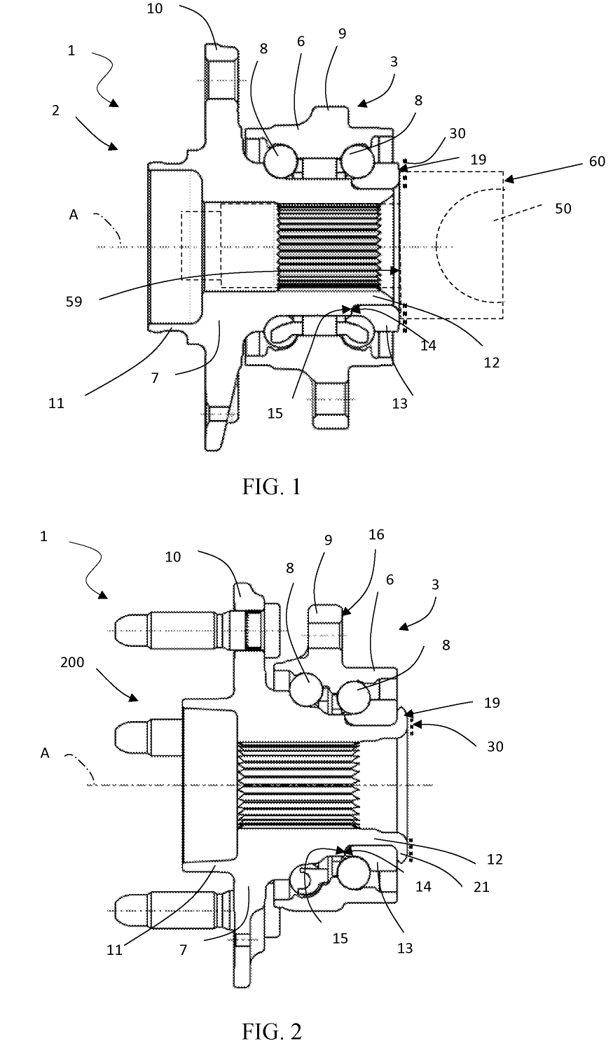

FIGS. 1 and 2 show respective examples of embodiment of the wheel hub unit.

In particular, FIG. 1 shows a wheel hub assembly 2 of the open type, where the axial locking of the inner rolling ring 7 is performed with assembly of the wheel hub unit 2 itself together with the constant velocity joint 60.

FIG. 2 shows, instead, according to a preferred embodiment of the present invention, the wheel hub assembly 1 comprising a wheel hub unit 200 of the asymmetrical type. In other words, the wheel hub unit 200 has two rows of rolling elements 8 of different diameters, and axial locking of the inner rolling ring 7 is performed by means of a deformed annular edge 21 which is cold-upset by means of orbital deformation. The deformed upset annular edge is upset against the insert ring 13, causing the axial locking thereof together with the inner ring 7.

In any case, the insert ring 13 or the inner ring 7 has a metallic annular surface 19 which is axially inner and axially abutting, in other words, coupled or able to be coupled so as to make contact, end-to-end, with a corresponding front surface 59-axially outer and also metallic-of the bell member 50 of the constant velocity joint 60.

The annular surface 19, according to the possible embodiments of the invention shown in FIGS. 1 and 2, may be defined by a front face of the insert ring 13 opposite the face 15 (FIG. 1) or by a front face of the annular edge 21 deformed and upset against the insert ring 13 (FIG. 2).

According to one aspect of the invention, the annular surface 19 is subjected to a superficial hardening and texturing treatment by means of a laser device. The laser, which is an abbreviation for “light amplification by stimulated emission of radiation”, is an optoelectronic device able to emit a coherent light beam, also called laser light. In fact, the term refers, in addition to the device, also to the physical phenomenon of amplification by means of stimulated emission of an electromagnet wave.

As a result of this treatment, the annular surface 19 therefore is hardened and has a high degree of friction. In other words, the annular surface 19 is provided with a plurality of superficial cut-away areas 30, i.e. grooves or imprints which increase the roughness of the surface, forming corresponding peaks and valleys. The laser texturing treatment is intended to control the friction between the annular surface 19 and the corresponding, mating, front surface 59 of the bell member 50 of the constant velocity joint 60.

This characteristic improves the annular surface 19, making it harder and rougher. In this way an incision effect is created on the corresponding front contact surface 59 of the bell member 50 and the interlocking effect between wheel hub unit and constant velocity joint is improved, reducing the noise significantly and improving the torque transfer.

The invention is applicable both to the wheel hub unit 2 according to FIG. 1 and to the wheel hub unit 200 according to FIG. 2. The wheel hub units 2, 200 therefore comprise these superficial cut-away areas in the metal surface 19 (of the insert ring 13 or the inner ring 7) which enable, depending on the design, a very low or very high degree of friction to be obtained between the two contact surfaces.

The laser texturing treatment may be applied:
onto only the annular surface 19 of the wheel hub unit 2, 200; this is undoubtedly the preferred solution, since the peaks resulting from the texturing treatment are very hard and able to cut into the corresponding front surface 59 of the bell member 50 with a high static friction effect;
onto only the front surface 59 of the bell member 50 of the constant velocity joint 60; this is an alternative to the previous solution with equivalent effects and advantages;
both onto the surface 19 of the wheel hub unit 2, 200 and onto the front surface 59 of the bell member 50 of the constant velocity joint 60; this is a further alternative solution which achieves better advantages compared to the previous solutions, but which inevitably has a greater cost.

The invention may also be applied to further surfaces which are affected by micro-slipping. For example and with reference to FIG. 2, it may be applied to the surface 16 of the flange 9 of the outer ring 6 which interfaces with a corresponding surface of the suspension upright.

In the following description, for simpler illustration, reference will be made to the annular surface 19 of the wheel hub unit, but it must be understood that all the characteristics of the annular surface 19 may also be applied to the other surfaces 59, 16 described above.

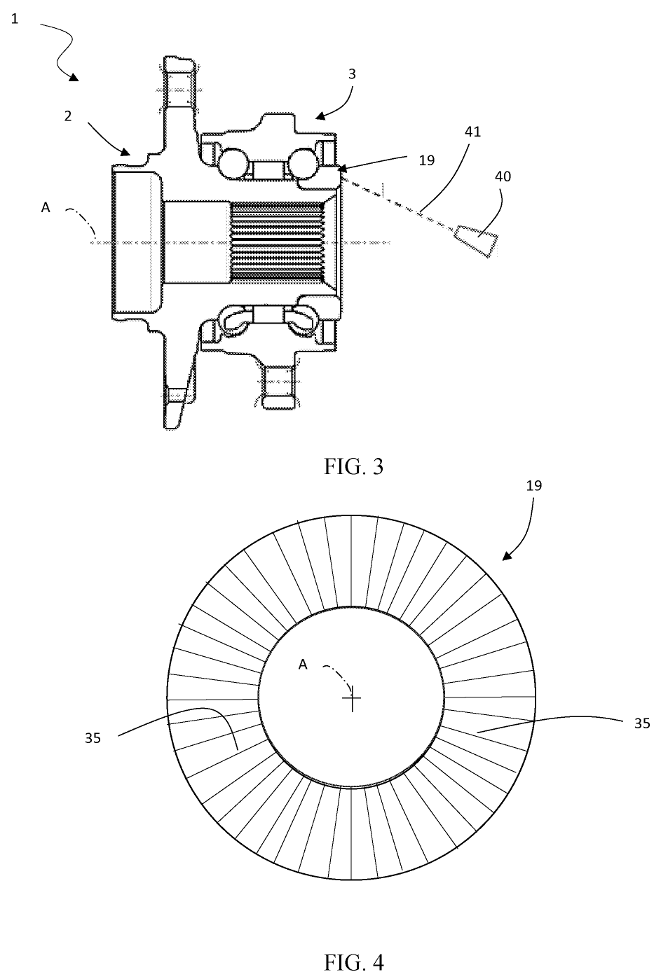

With reference to FIG. 3, the texturing of the annular surface 19 may be obtained by means of localized laser treatment on the contact surface, using a device 40 of the known type. A non-limiting example of a device for applying such laser texturing is as follows: a fiber laser with a wavelength close to the infrared range, for example 1062 nm, with a power range of between 100W and 500W. With this technology it is possible to create the hardened surface layer and a deep texture in a short amount of time (suitable for cycle time in the mass production of wheel hub units), without a high thermal impact on the substrate and the surrounding material.

The annular surface 19 textured with the laser must have a number of fundamental characteristics.

First, the annular surface 19 must have a high degree of roughness which may be objectively defined by a number of parameters and, in particular:
the arithmetic mean roughness Ra. This represents the average height of the surface roughness in relation to the median line. Conveniently, the value of Ra may vary between 10 mm and 25 mm. An Ra value within this range increases the actual contact area between the surfaces, improving the imprint on the smooth untreated surface, namely the contact surface of the bell member of the joint. An Ra value of less than 10 mm might not provide a sufficient gripping effect, while an excessively high Ra value of more than 25 mm could result in premature wear or an irregular distribution of the pressure between the two contact surfaces; and
the roughness Rz, namely the average depth of the surface profile obtained along a given measurement line. The roughness Rz is the average distance between the maximum and minimum points of the profile, i.e. it defines the difference between the highest peak and the lowest valley within the measurement line. Conveniently, the value of Rz may vary between 85 mm and 150 mm. An Rz value within this range indicates deeper texture characteristics, increasing the capacity of the treated annular surface 19 to imprint onto the corresponding smooth surface, increasing the contact area of the bell member of the joint. An Rz value less than 85 mm might not provide a sufficient gripping effect, while an excessively high Rz value, greater than 150 mm may increase the initial resistance to slipping, but if too extreme, may reduce the actual contact area, with consequent high localized pressures and potential wear.

Advantageously moreover:
the root mean square roughness Rq. The roughness Rq is defined as being the root mean square of the deviations of the profile from the median line. It is similar to the roughness Ra but is more sensitive to the presence of peaks and valleys with an extreme value because it is a quadratic measurement. Conveniently, the values of Rq may vary between 15 mm and 30 mm, for the same reasons already mentioned in connection with the arithmetic mean roughness Ra.
the peak variation index Rq/Ra. This index measures the uniformity of the texture: if Rq ≈ Ra the texture is relatively uniform, without extreme peaks. This index is conveniently kept within the range of values of between 1.1 and 1.5, and therefore with Rq being slightly greater than Ra, so as to have a texture with peaks which are pronounced (but not excessively so) so as to help improve the interlocking action between the wheel hub unit and the constant velocity joint and the anti-slip behavior.
the extreme roughness index Rz/Ra. Conveniently this index must be within the range of 4 to 8, i.e. the roughness Rz should be 4-8 times the roughness Ra so as to achieve a well-distributed roughness without excessive peaks or valleys. Rz values much greater than the Ra values (Rz/Ra > 8) indicate the presence of extreme roughness which may negatively influence the characteristics of the performance, reducing the actual contact area with high localized pressures.

Therefore, the above-mentioned operating ranges are important for obtaining the desired performance (high friction and superficial imprint), without causing negative effects due to the anomalous distribution of the pressure or wear on the coupling surfaces.

With reference to FIG. 4, the annular surface 19 must also have an optimized texturing model. Good experimental results are obtained with optimized laser texturing in the form of a plurality of radial lines or grooves 35.

In this way the friction coefficient will be maximum in the circumferential direction and may therefore counteract any slipping due to torque reversal.

By operating in this way, the laser process is also optimized so as to achieve maximum processing efficiency. This happens because a galvanometric laser head moves fast in a continuous manner along a predefined path, instead of there being a series of stoppages and restarts necessary to achieve, for example, point-by-point texturing. This reduces the mechanical inertia and reduces to a minimum the distance which the laser must travel, with consequent faster and more efficient processing.

The hardened superficial layer of the annular surface 19 also has special characteristics:
The base material is a carbon steel (for example, an AISI 1055 class steel) which is sufficiently ductile and malleable, making it suitable for creating the annular edge 21 deformed and cold-upset by means of orbital deformation. Moreover, it is surface hardened and annealed. On this type of material, it is possible to carry out, according to the prior art, induction hardening along the roiling tracks of the bearing unit in order to improve the surface hardness and the wear resistance. According to the present invention, instead laser hardening is used, which allows precise control of the hardened area, without a negative impact on the substrate (no cracks or residual stresses). In fact, with induction hardening, after heating the steel to a temperature of about 900° C.-950° C. so as to bring the material above the austenitization point, cooling is performed by means of a spraying with water in an emulsion with other substances. Instead, in the case of laser hardening, the process involves absorption of the energy from the laser by the surface layer of the material, followed by the consequent thermal diffusion and change in state from pearlite to austenite in the same material surface layer, and, finally, cooling of the thin surface layer heated by the laser beam, which takes place without the use of external means, owing to the mass of adjacent material which acts as a cold source. This makes the laser hardening process more precise and controllable compared to induction hardening.
The hardness must be increased from 300 HV 0.5, which is the typical condition of the base material, to values greater than 500 HV 0.5, for example 700 HV 0.5.
The depth of the hardened layer is between 10 μm and 50 μm.

The operating principle, the physical effect and the results in terms of an improvement in the performance have been confirmed by experimental tests. In particular, it has been established that laser texturing:
increases the contact surface area between the wheel hub unit and the constant velocity joint by 20-33%. In the specific case of the wheel hub unit 200, this eliminates the need to increase the surface of the annular edge 21 deformed and cold-upset by means of the complex orbital deformation process and, more generally, also for the wheel hub unit 2, the machining operations required to create a greater flat zone of the annular surface 19;
it creates peaks on a hardened surface and therefore several localized high pressure points also in zones which are less subject to stress;
it allows the treated surface 19 to cut deeply into the coupling surface of the bell member 50 of the constant velocity joint 60;
consequently, it allows a higher torque transfer without micro-slipping effects, reducing substantially the noise level.

Basically, the proposed invention offers numerous advantages which include the reduction or the elimination of micro-slipping, making the wheel hub unit substantially silent when subject to external stresses. Moreover, the invention allows a simple and low-cost design to be maintained, with smaller overall dimensions and relatively low assembly costs.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A wheel hub unit for vehicles, the wheel hub unit comprising:
a radially outer ring;
a radially inner ring having an axially-inner annular surface configured to axially abut another component; and
a plurality of rolling elements interposed between the inner and outer rings such that the inner and outer rings are relatively rotatable;
wherein the annular surface of the inner ring is superficially hardened and textured by laser light so as to have an arithmetic mean roughness (Ra) ranging between 10 μm and 25 μm and a profile with an average depth (Rz) ranging between 85 μm and 150 μm.

2. The wheel hub unit according to claim 1, wherein the annular surface of the inner ring has a root mean square roughness (Rq) ranging between 15 μm and 30 μm.

3. The wheel hub unit according to claim 1, wherein the annular surface of the inner ring has a peak variation index (Rq/Ra) ranging between 1.1 and 1.5.

4. The wheel hub unit according to claim 1, wherein the annular surface of the inner ring has an extreme roughness index (Rz/Ra) ranging between 4 and 8.

5. The wheel hub unit according to claim 1, wherein texturing of the annular surface of the inner ring includes a plurality of radial lines or grooves.

6. The wheel hub unit according to claim 1, wherein the annular surface of the inner ring has a hardness greater than 500 HV 0.5.

7. The wheel hub unit according to claim 1, wherein the annular surface of the inner ring has a hardened layer depth ranging between 10 μm and 50 μm.

8. A wheel hub assembly for vehicles comprising:
a wheel hub unit including a radially outer ring, a radially inner ring having an axially-inner and metallic annular surface, and a plurality of rolling elements interposed between the inner and outer rings such that the inner and outer rings are relatively rotatable; and
a bell member of a constant velocity joint, the bell member having an axially outer and metallic annular surface, the annular surface of the bell member and the annular surface of the inner ring forming an abutting pair of surfaces for mating between the wheel hub unit and the bell member of the constant velocity joint;
wherein at least one surface of the pair of mating surfaces being superficially hardened and textured by laser light so as to have an arithmetic mean roughness (Ra) ranging between 10 μm and 25 μm and a profile with an average depth (Rz) ranging between 85 μm and 150 μm.

9. The wheel hub assembly according to claim 8, wherein the front surface of the bell member has at least one of:
a root mean square roughness (Rq) ranging between 15 μm and 30 μm;
a peak variation index (Rq/Ra) ranging between 1.1 and 1.5;
an extreme roughness index (Rz/Ra) ranging between 4 and 8;
texturing in the form of a plurality of radial lines or grooves (35);
a hardness greater than 500 HV 0.5; and
a hardened layer depth ranging between 10 μm and 50 μm.
